(19) United States
(12) Patent Application Publication
(10) Pub. No.: US 2023/0134512 A1
(43) Pub. Date: May 4, 2023

(54) ENERGY STORAGE APPARATUS

(71) Applicant: GS Yuasa International Ltd., Kyoto (JP)

(72) Inventors: Jiromasa MURAMATSU, Kyoto (JP); Motonobu MURAKAMI, Kyoto (JP); Daisuke KONISHI, Kyoto (JP)

(21) Appl. No.: 17/911,535

(22) PCT Filed: Mar. 19, 2021
(86) PCT No.: PCT/JP2021/011288

§ 371 Date: Sep. 14, 2022

(30) Foreign Application Priority Data
Mar. 27, 2020 (JP) 2020-058651

(51) Int. Cl. H02J 7/00; H01M 4/40; H01M 10/44

(52) U.S. Cl. CPC H02J 7/007; H01M 4/405; H01M 10/441; H02J 7/0024; H01M 2220/20

(57) ABSTRACT

An energy storage apparatus used in a flight vehicle includes battery circuits connected in series, through which current flows during charge and discharge of the energy storage apparatus. Each of the battery circuits includes: a first electrical path; an energy storage cell connected to an adjacent battery circuit through the first electrical path; a first switch that includes a diode and is provided in the first electrical path such that a forward direction of the diode is a charge direction of the energy storage apparatus; a second electrical path connected to the adjacent battery circuit in parallel with the energy storage cell and the first switch; and a second switch that includes a diode and is provided in the second electrical path such that a forward direction of the diode is a discharge direction of the energy storage apparatus, and is turned on when the first switch is turned off.

### CROSS REFERENCE TO RELATED APPLICATIONS

This application is a National Stage Application, filed under 35 U.S.C. § 371, of International Application No. PCT/JP2021/011288, filed Mar. 19, 2021, which claims priority to Japanese Application No. 2020-058651, filed Mar. 27, 2020; the contents of both of which are hereby incorporated by reference in their entirety.

### BACKGROUND

### Related Field

The present invention relates to an energy storage apparatus.

### Description of Related Art

Conventionally, electric flight vehicles have been developed. For example, it is planned that a high-altitude platform station (HAPS) is implemented by mounting a wireless relay station on an electric flight vehicle. The flight vehicle used as the HAPS includes a solar cell and an energy storage apparatus and is required to continue a non-landing flight for a long period of time such as half a year. The flight vehicle used as the HAPS flies using electric power generated by the solar cell in the daytime and also charges the energy storage apparatus, and flies using the electric power charged in the energy storage apparatus at night. Patent Document JP-A-2019-54490 discloses a technique of configuring a communication network using the HAPS.

### BRIEF SUMMARY

The energy storage apparatus used in the HAPS requires a high discharge capacity (full charge capacity). In a lithium ion battery, it is known that the discharge capacity is significantly increased by changing an active material of a negative electrode from graphite to metallic lithium. In the lithium ion battery in which the metallic lithium is used as the active material of the negative electrode, the metallic lithium is deposited in a dendrite shape during charge, and a short circuit may occur inside an energy storage cell. Timing at which the short circuit occurs varies depending on the energy storage cell, and it is difficult to predict the timing at which the short circuit occurs in each energy storage cell. In the energy storage apparatus used in the HAPS, it is desirable to continue the operation of the HAPS for a long period of time using a large number of energy storage cells.

An object of the present invention is to provide an energy storage apparatus capable of continuing operation even when some energy storage cells become abnormal.

An energy storage apparatus used in a flight vehicle according to one aspect of the present invention includes a plurality of battery circuits connected in series, through which a current flows during charge and discharge of the energy storage apparatus. Each of the battery circuits includes: a first electrical path; an energy storage cell connected to an adjacent battery circuit through the first electrical path; a first switch including a diode and provided in the first electrical path such that a forward direction of the diode is a charge direction of the energy storage apparatus; a second electrical path connected to the adjacent battery circuit in parallel with the energy storage cell and the first switch; and a second switch including a diode and provided in the second electrical path such that the forward direction of the diode is a discharge direction of the energy storage apparatus, and is turned on when the first switch is turned off.

With the above configuration, the energy storage apparatus can continue the operation even when some of the energy storage cells are abnormal.

### BRIEF DESCRIPTION OF THE FIGURES

FIG. 1 is a schematic diagram illustrating an arrangement example of an energy storage apparatus.

FIG. 2 is a block diagram illustrating an example of a functional configuration of an inside of the energy storage apparatus according to a first embodiment.

FIG. 3 is a schematic sectional view illustrating a configuration example of an inside of an energy storage cell.

FIG. 4 is a flowchart illustrating a procedure of processing in which a CMU controls operation of the energy storage apparatus.

FIG. 5 is a schematic circuit diagram illustrating the energy storage apparatus that performs charge and discharge when all energy storage cells are normal.

FIG. 6 is a schematic circuit diagram illustrating the energy storage apparatus that performs the charge and the discharge when one energy storage cell is abnormal.

FIG. 7 is a flowchart illustrating a procedure of processing in which the CMU diagnoses a second switch.

FIG. 8 is a schematic circuit diagram illustrating a battery circuit when the second switch is diagnosed.

FIG. 9 is a flowchart illustrating a procedure of processing in which the CMU diagnoses a first switch.

FIG. 10 is a schematic circuit diagram illustrating the battery circuit when the first switch is diagnosed.

FIG. 11 is a block diagram illustrating an example of a functional configuration of an inside of an energy storage apparatus according to a second embodiment.

### DETAILED DESCRIPTION OF VARIOUS EMBODIMENTS

An energy storage apparatus used in a flight vehicle includes: a plurality of battery circuits connected in series, through which a current flows during charge and discharge of the energy storage apparatus. Each of the plurality of battery circuits includes: a first electrical path; an energy storage cell connected to an adjacent battery circuit through the first electrical path; a first switch that includes a diode and is provided in the first electrical path such that a forward direction of the diode is a charge direction of the energy storage apparatus; a second electrical path connected to the adjacent battery circuit in parallel with the energy storage cell and the first switch; and a second switch that includes a diode and is provided in the second electrical path such that a forward direction of the diode is a discharge direction of the energy storage apparatus, and is turned on when the first switch is turned off.

The energy storage apparatus includes the battery circuits connected to each other, each of which has the energy storage cell. The battery circuit includes the energy storage cell, the first switch that opens and closes the first electrical path in order to connect the energy storage cell to another battery circuit, and the second electrical path and the second switch that are parallel to the energy storage cell and the first switch. When the first switch is turned off, the second switch is turned on, and the current bypasses the energy storage cell and flows through the second electrical path. Even when some of the energy storage cells included in the energy storage apparatus cannot be used, the current flows through the plurality of battery circuits, and the energy storage apparatus can continue the operation.

The energy storage apparatus may further include a controller that controls switching between turn-on and turn-off of the first switch and the second switch such that a positive electrode terminal and a negative electrode terminal of the energy storage cell are not short-circuited outside the energy storage cell, in each battery circuit. As described above, the controller switches turn-on and turn-off of the first switch and the second switch, so that the current can bypass the energy storage cell and flow through the second electrical path.

The controller may determine that the energy storage cell is normal or abnormal, turn off the first switch in the battery circuit including the energy storage cell determined to be abnormal, and then turn on the second switch. When the energy storage apparatus is abnormal, the controller turns off the first switch and then turns on the second switch. When the energy storage cell is abnormal, the energy storage cell is disconnected from another battery circuit, and the current flows through the second electrical path. The first switch and the second switch are not simultaneously turned on, and an external short-circuit is prevented from occurring in the energy storage cell.

The controller may determine that the energy storage cell is normal or abnormal based on voltage of the energy storage cell. When an internal short-circuit occurs in the energy storage cell, the voltage between the positive and negative electrode terminals of the energy storage cell decreases. The controller can determine the abnormality of the energy storage cell due to the internal short-circuit based on the voltage of the energy storage cell.

The controller may determine that the energy storage cell is normal or abnormal based on voltage of the energy storage cell at the time of charging the energy storage cell. A dendrite that causes the internal short-circuit of the energy storage cell is easily precipitated during the charge of the energy storage cell. The controller can timely determine the abnormality of the energy storage cell by making the determination based on the voltage of the energy storage cell during the charge.

The first switch and the second switch may be configured using an FET, and the controller may diagnose that one of the first switch and the second switch is normal or abnormal while charging, and diagnose that the other of the first switch and the second switch is normal or abnormal while discharging. Whether the first switch and the second switch are normal can be diagnosed from the voltage when the FET is turned on and the voltage when the current flows through a body diode (parasitic diode) of the FET while the FET is turned off. The direction of the current is opposite between the charge and the discharge. The polarities of the first switch and the second switch are reversed, the current is caused to flow through one body diode of the first switch and the second switch during the charge, and the current is caused to flow through the other body diode during the discharge, so that a failure diagnosis can be performed.

An energy storage apparatus includes a plurality of battery circuits connected in series, through which current flows during charge and discharge of the energy storage apparatus. Each of the battery circuits includes: a first electrical path; an energy storage cell connected to an adjacent battery circuit through the first electrical path; a first switch provided in the first electrical path; a second electrical path connected to the adjacent battery circuit in parallel with the energy storage cell and the first switch; and a second switch that is provided in the second electrical path and is turned on when the first switch is turned off. One of a diode included in the first switch and a diode included in the second switch is disposed such that a charge direction of the energy storage apparatus is a forward direction, and the other of the diodes is disposed such that a discharge direction of the energy storage apparatus is the forward direction. Even in an environment other than the flight vehicle, when some of the energy storage cells included in the energy storage apparatus cannot be used, the current flows through the battery circuits, and the energy storage apparatus can continue the operation.

An active material of a negative electrode of the energy storage cell may be metallic lithium or an alloy containing lithium. In the energy storage cell in which the active material of the negative electrode is the metallic lithium or the alloy containing the lithium, the dendrite lithium metal is easily precipitated although the discharge capacity is large, and the internal short-circuit caused by the dendrite lithium easily occurs. In addition, the energy storage apparatus continues the operation even when the internal short-circuit occurs in some of the energy storage cells, so that the energy storage apparatus can operate for a long period of time even when the energy storage cell in which the active material of the negative electrode is the metallic lithium or the alloy containing the lithium is used. The energy storage apparatus can increase the discharge capacity and the discharge energy density using the energy storage cell in which the active material of the negative electrode is the metallic lithium or the alloy containing the lithium.

Hereinafter, the present invention will be specifically described based on the drawings illustrating embodiments.

### First Embodiment

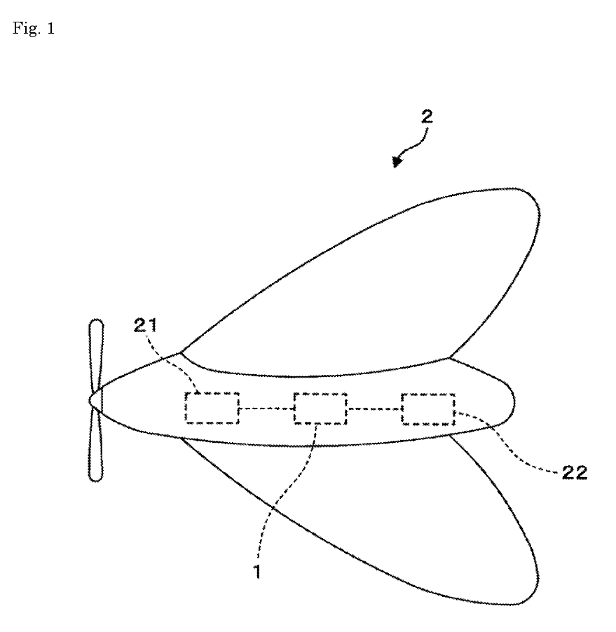

FIG. 1 is a schematic diagram illustrating an arrangement example of an energy storage apparatus 1. The energy storage apparatus 1 is provided in a flight vehicle 2. For example, the flight vehicle 2 is a HAPS. The flight vehicle 2 includes a load 21 such as a motor that generates power for flight and a communication device, and a solar cell 22. The load 21 and the solar cell 22 are connected to the energy storage apparatus 1. The power generated by the solar cell 22 is supplied to the energy storage apparatus 1 and is charged. The energy storage apparatus 1 discharges electricity and supplies the electric power to the load 21. The electric power generated by the solar cell 22 and the electric power discharged by the energy storage apparatus 1 are supplied to a motor that generates power for causing the flight vehicle 2 to fly. The solar cell 22 and the energy storage apparatus 1 may be connected in parallel to the load 21.

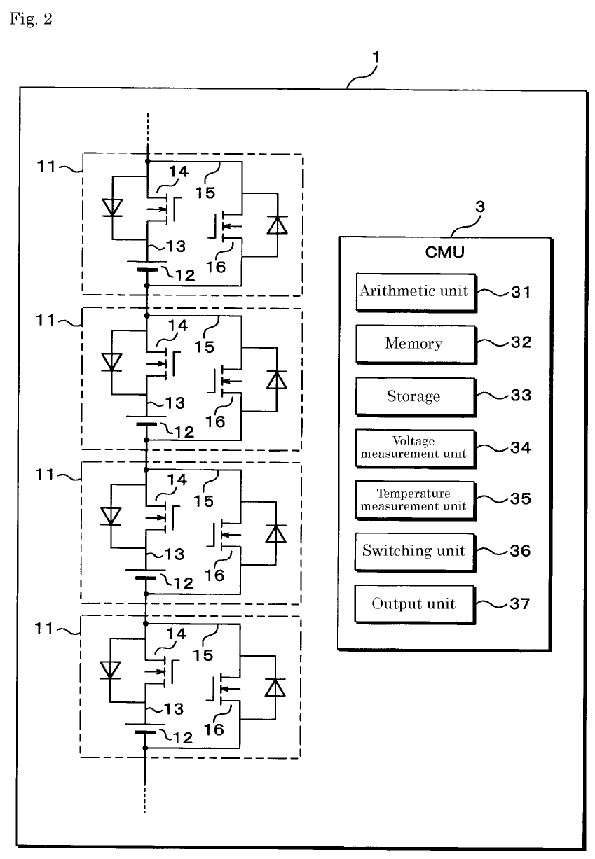

FIG. 2 is a block diagram illustrating an example of a functional configuration of an inside of the energy storage apparatus 1 according to a first embodiment. The energy storage apparatus 1 includes a plurality of battery circuits 11. Each battery circuit 11 includes one energy storage cell 12, and is a circuit through which current flows when the energy storage apparatus 1 performs the charge and the discharge. The plurality of battery circuits 11 are connected in series. The plurality of energy storage cells 12 are connected to the load 21 and the solar cell 22 outside the energy storage apparatus 1. When the energy storage apparatus 1 performs the charge and the discharge, a current flows through the plurality of battery circuits 11, and the plurality of energy storage cells 12 perform the charge and the discharge.

The battery circuit 11 includes a first electrical path 13, the energy storage cell 12 provided in the first electrical path 13, and a first switch 14 that is provided in the first electrical path 13 and connected in series to the energy storage cell 12. The energy storage cell 12 is connected to another (adjacent) battery circuit 11 through the first electrical path 13 and the first switch 14. The first switch 14 is configured using a field effect transistor (FET). The first switch 14 is provided in the first electrical path 13 such that a forward direction of a body diode of the first switch 14 is a charge direction of the energy storage apparatus 1. The first switch 14 brings the first electrical path 13 into a conductive state during a turn-on state, and brings the first electrical path 13 into a non-conductive state in a discharge direction of the energy storage apparatus 1 during a turn-off state. Specifically, when the first switch 14 is turned on, the energy storage cell 12 is connected to another battery circuit 11 through the first electrical path 13, and can perform the charge and the discharge. When the first switch 14 is turned off, the current does not flow through the energy storage cell 12 in the discharge direction, but the current flows through the body diode of the first switch 14 in the charge direction.

The battery circuit 11 further includes a second electrical path 15 connected to another battery circuit 11 in parallel to the energy storage cell 12 and the first switch 14, and a second switch 16 provided in the second electrical path 15. The second switch 16 is configured using the FET. The first switch 14 and the second switch 16 are connected in the battery circuit 11 so as to have opposite polarities. The second switch 16 is provided in the second electrical path 15 such that the forward direction of the body diode of the second switch 16 is the discharge direction of the energy storage apparatus 1. In a certain battery circuit 11, when the second switch 16 is turned on while the first switch 14 is turned off, the charge current does not flow to the energy storage cell 12, but the charge current flows to another battery circuit while the second electrical path 15 becomes a bypass to detour around the energy storage cell 12.

The second switch 16 is turned on when the first switch 14 is turned off. The second switch 16 brings the second electrical path 15 into the conductive state when turned on, and brings the second electrical path 15 into the non-conductive state in the charge direction of the energy storage apparatus 1 during the turn-off state. When the first switch 14 is turned on while the second switch 16 is turned off, the energy storage cell 12 is connected to another battery circuit 11 through the first electrical path 13.

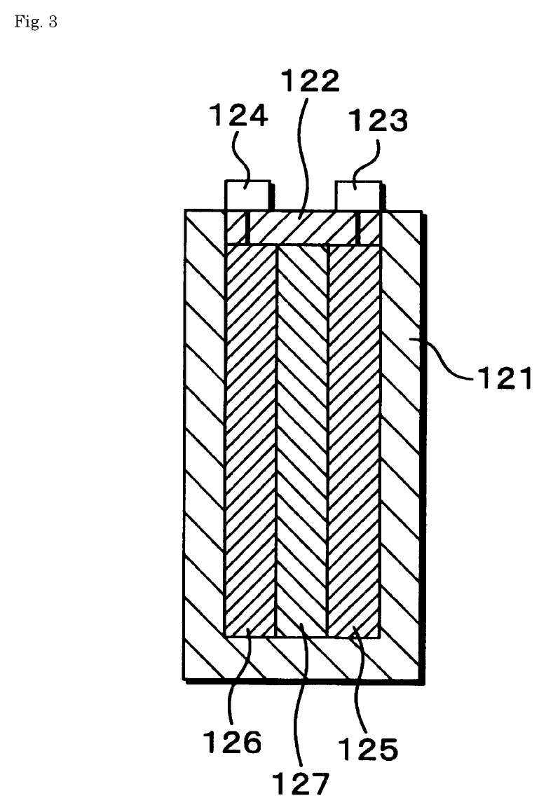

FIG. 3 is a schematic sectional view illustrating a configuration example of an inside of the energy storage cell 12. For example, the energy storage cell 12 is an energy storage device of a secondary battery such as a lithium ion battery. The energy storage cell 12 is configured to accommodate a positive electrode 125, a separator 127, a negative electrode 126, and an electrolyte (electrolyte solution) in a rectangular parallelepiped case 121 in which one surface is opened, and to attach a lid 122 to the case 121. A positive electrode terminal 123 and a negative electrode terminal 124 are provided outside the lid 122 in order to perform electric connection with a circuit. Alternatively, the case 121 may be configured using a laminate film. The positive electrode terminal 123 is connected to the positive electrode 125 in the case 121, and the negative electrode terminal 124 is connected to the negative electrode 126 in the case 121.

The positive electrode 125, the separator 127, and the negative electrode 126 are formed in a rectangular flat plate shape or a sheet shape. The positive electrode 125, the separator 127, and the negative electrode 126 are stacked, and the separator 127 is interposed between the positive electrode 125 and the negative electrode 126. For example, the positive electrode 125 is made of a material containing a lithium transition metal oxide, and the negative electrode 126 is made of metallic lithium or an alloy containing lithium. For example, the lithium-containing alloy is an alloy of tin or silicon and lithium. When the negative electrode 126 is made of metallic lithium or an alloy containing lithium, the active material of the negative electrode 126 is metallic lithium or an alloy containing lithium. For example, the separator 127 is glass cloth or a resin formed in a porous shape. The separator 127 is impregnated with an electrolyte. The positive electrode 125, the separator 127, and the negative electrode 126 may be wound or laminated. The shape of the energy storage cell 12 may be a shape other than a rectangular parallelepiped (prismatic), and may be a pouch shape or a cylindrical shape.

When the active material of the negative electrode 126 is the metallic lithium or the alloy containing lithium, the discharge capacity is significantly increased as compared with the case where the active material of the negative electrode is graphite, but a dendrite lithium metal is easily precipitated from the negative electrode 126. The dendrite lithium metal is easily precipitated particularly during the charge of the energy storage cell 12. The dendrite lithium metal from the negative electrode 126 grows at every charge and discharge, penetrates the separator 127, and comes into contact with the positive electrode 125. When the dendrite lithium metal from the negative electrode 126 comes into contact with the positive electrode 125, the short circuit occurs inside the energy storage cell 12. The energy storage cell 12 in which the internal short-circuit has occurred is in an abnormal state in which the normal operation cannot be performed.

As illustrated in FIG. 2, the energy storage apparatus 1 includes a cell monitoring unit (CMU) 3. The CMU 3 is a circuit board mounted on a battery module or a battery pack (energy storage apparatus 1). In the embodiment, the CMU 3 corresponds to a controller. The CMU 3 measures states of the plurality of energy storage cells 12 and controls the plurality of battery circuits 11. The CMU 3 includes an arithmetic unit 31, a memory 32, a storage 33, a voltage measurement unit 34, a temperature measurement unit 35, a switching unit 36, and an output unit 37. For example, the arithmetic unit 31 is a central processing unit (CPU). The memory 32 stores information required for arithmetic operation in the arithmetic unit 31. The storage 33 is nonvolatile and stores programs and data. For example, the storage 33 is a nonvolatile semiconductor memory. The arithmetic unit 31 executes processing according to the program stored in the storage 33. The voltage measurement unit 34 measures voltage between the positive and negative electrode terminals of each of the energy storage cells 12. For example, the voltage measurement unit 34 includes a voltmeter connected to a positive terminal and a negative terminal of each of the energy storage cells 12. The temperature measurement unit 35 measures a temperature of each of the energy storage cells 12. The output unit 37 outputs a signal to the outside of the energy storage apparatus 1.

The CMU 3 is connected to the first switch 14 and the second switch 16, and controls operations of the first switch 14 and the second switch 16. The switching unit 36 turns on and off of each of the first switch 14 and the second switch 16. For example, the switching unit 36 applies the voltage between a source and a gate of the FET constituting the first switch 14 and the second switch 16. The first switch 14 and the second switch 16 are turned on when the switching unit 36 applies the voltage exceeding a predetermined voltage, and the first switch 14 and the second switch 16 are turned off when the applied voltage is decreased. When the FET is intentionally turned off, the applied voltage may be set to zero, or the applied voltage may be set to a negative voltage. The voltage measurement unit 34 measures the voltages of the first switch 14 and the second switch 16. For example, the voltage measurement unit 34 measures the voltage between the source and a drain of each of the first switch 14 and the second switch 16.

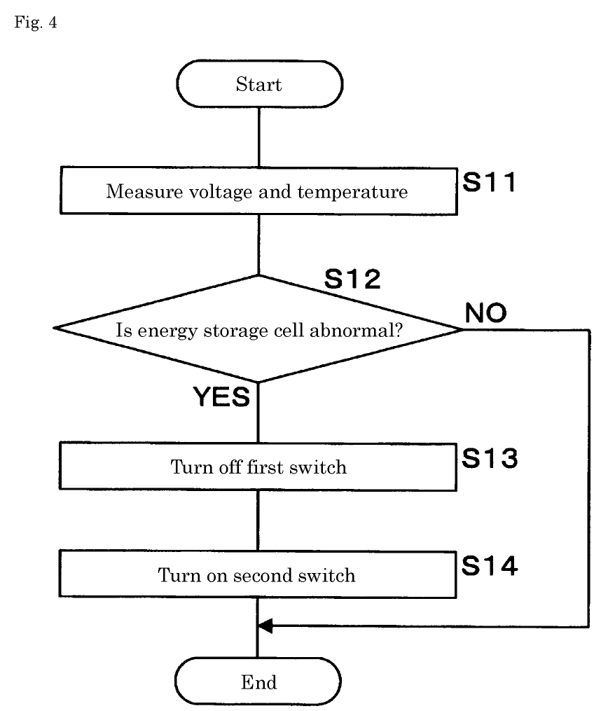

FIG. 4 is a flowchart illustrating a procedure of processing in which the CMU 3 controls the operation of the energy storage apparatus 1. In an initial state, all of the plurality of first switches 14 are turned on, and all of the plurality of second switches 16 are turned off. The voltage measurement unit 34 measures the voltage of the energy storage cell 12, and the temperature measurement unit 35 measures the temperature of the energy storage cell 12 (S11). The arithmetic unit 31 determines whether the energy storage cell 12 is abnormal based on the measured voltage and temperature (S12). When the short circuit (internal short-circuit) is caused inside the energy storage cell 12, the voltage of the energy storage cell 12 decreases and the temperature of the energy storage cell 12 increases. For example, in S12, the arithmetic unit 31 determines that the energy storage cell 12 is abnormal when the measured voltage is less than a predetermined threshold voltage or when the measured temperature is greater than or equal to the predetermined threshold temperature. The arithmetic unit 31 may determine that the energy storage cell 12 is abnormal when the measured voltage is less than or equal to the predetermined threshold voltage or when the measured temperature exceeds the predetermined threshold temperature. When the energy storage cell 12 is normal (NO in S12), the CMU 3 ends the processing.

When the energy storage cell 12 is abnormal (YES in S12), the arithmetic unit 31 turns off the first switch 14 in the battery circuit 11 including the energy storage cell 12 determined to be abnormal by the switching unit 36 (S13). Both the first switch 14 and the second switch 16 are turned off from the time when S13 is performed to the time when S14 is performed. When both the first switch 14 and the second switch 16 are turned off while the energy storage apparatus 1 is charging, the charge current temporarily flows through the body diode of the first switch 14. When both the first switch 14 and the second switch 16 are turned off while the energy storage apparatus 1 is discharging, the discharge current temporarily flows through the body diode of the second switch 16.

Subsequently, the arithmetic unit 31 turns on the second switch 16 in the battery circuit 11 including the energy storage cell 12 determined to be abnormal by the switching unit 36 (S14). The second electrical path 15 is brought into the conductive state, and the abnormal energy storage cell 12 is brought into a state of not being connected to another battery circuits 11, so that the charge and the discharge are not performed. When the energy storage cell 12 in which the internal short-circuit is caused continues the charge or the discharge, the dendrite lithium metal further grows, and the dendrite lithium metal may come into contact with air and be fired. The abnormal energy storage cell 12 stops the charge and the discharge, so that a risk of firing is reduced, and safety of the energy storage apparatus 1 is improved. The arithmetic unit 31 performs the processing of S14 after a predetermined time elapses since the first switch 14 is turned off in S13. When the first switch 14 and the second switch 16 are simultaneously turned on, an external short-circuit is caused in the energy storage cell 12. When the external short-circuit occurs, a large current flows through the battery circuit 11, and the energy storage apparatus 1 is in danger of being damaged. The CMU 3 turns off the first switch 14 and then turns on the second switch 16 to prevent the generation of the external short-circuit. The CMU 3 ends the processing. The CMU 3 repeatedly executes the pieces of processing of S11 to S14 for each of the plurality of energy storage cells 12. For the energy storage cell 12 once determined to be abnormal, the CMU 3 may not perform the pieces of processing of S11 to S14 thereafter.

The dendrite lithium metal inside the energy storage cell 12 is easily caused during the charge of the energy storage cell 12. During the charge, the CMU 3 desirably executes the pieces of processing of S11 to S14 for each of the plurality of energy storage cells 12. By executing the pieces of processing of S11 to S14 during the charge, the energy storage apparatus 1 can immediately find the abnormal energy storage cell 12 to effectively eliminate the danger. The CMU 3 may perform the processing of determining the abnormality of the energy storage cell 12 based on only one of the voltage and the temperature of the energy storage cell 12. The CMU 3 that determines the abnormality of the energy storage cell 12 based only on the voltage of the energy storage cell 12 may not include the temperature measurement unit 35.

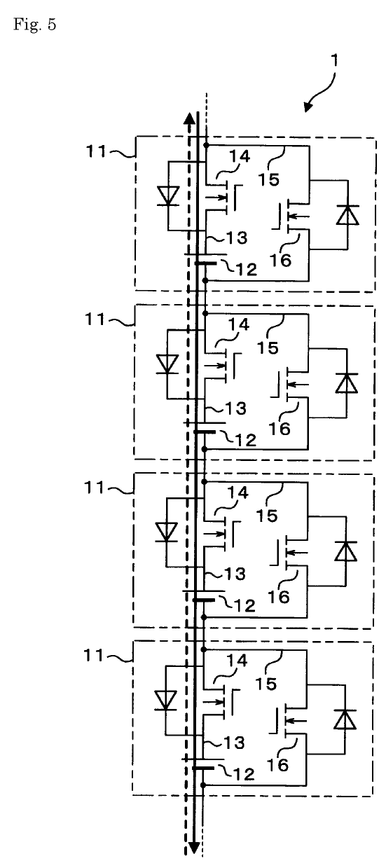

FIG. 5 is a schematic circuit diagram illustrating the energy storage apparatus 1 that performs the charge and the discharge when all the energy storage cells 12 are normal. The current flowing during the charge (charge current) is indicated by a solid arrow, and the current flowing during the discharge (discharge current) is indicated by a broken arrow. The plurality of energy storage cells 12 are connected to each other through the first electrical path 13. The current flows through the energy storage cell 12 and the first electrical path 13, and all the energy storage cells 12 perform the charge and the discharge.

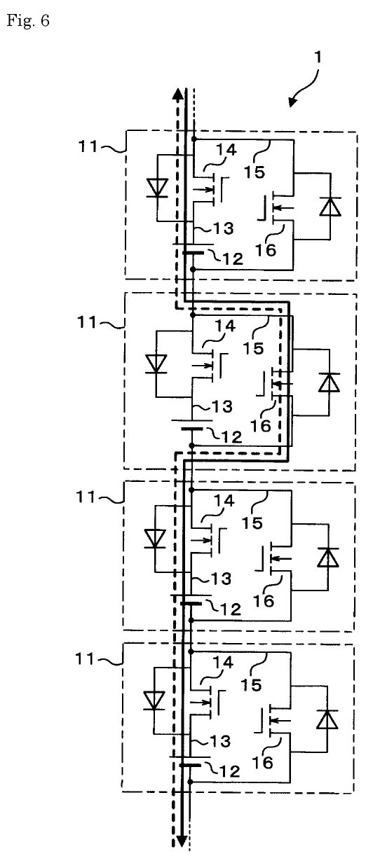

FIG. 6 is a schematic circuit diagram illustrating the energy storage apparatus 1 that performs the charge and the discharge when one energy storage cell 12 is abnormal. The current flowing during the charge is indicated by a solid arrow, and the current flowing during the discharge is indicated by a broken arrow. It is assumed that the second energy storage cell 12 from the top in FIG. 6 is abnormal. In the battery circuit 11 including the abnormal energy storage cell 12, the first switch 14 is turned off, and the energy storage cell 12 is not connected to another battery circuits 11. The second switch 16 is turned on, and the second electrical path 15 is in the conductive state. In the battery circuit 11 including the normal energy storage cell 12, the first switch 14 is turned on, and the energy storage cell 12 is connected to another battery circuit 11 through the first electrical path 13. The second switch 16 is turned off, and the second electrical path 15 is in the non-conductive state.

In the battery circuit 11 including the normal energy storage cell 12, the current flows through the energy storage cell 12 and the first electrical path 13, and the energy storage cell 12 performs the charge and the discharge. In the battery circuit 11 including the abnormal energy storage cell 12, the current does not flow through the energy storage cell 12 and the first electrical path 13, but the current flows through the second electrical path 15. That is, the current does not flow through the abnormal energy storage cell 12, but the second electrical path 15 serves as the bypass and the current flows through the second electrical path 15. The current flows through the entire energy storage apparatus 1, and the normal energy storage cell 12 performs the charge and the discharge.

As described above, in the first embodiment, even when some of the energy storage cells 12 are abnormal, the current flows bypassing the abnormal energy storage cell 12, other energy storage cells 12 operate normally, and the charge and the discharge are performed in the entire energy storage apparatus 1. Even when the internal short-circuit is caused in some of the energy storage cells 12 and some of the energy storage cells 12 become abnormal, the energy storage apparatus 1 can continue the operation.

The energy storage apparatus 1 included in the flight vehicle 2 used as the HAPS is required to have the high discharge capacity. In the energy storage cell 12 in which the active material of the negative electrode 126 is the metallic lithium or the alloy containing the lithium, the dendrite lithium metal is easily precipitated although the discharge capacity is large, and the internal short-circuit caused by the dendrite lithium metal is easily generated. The precipitation of the dendrite lithium metal is affected by a current distribution in the negative electrode 126, and the current distribution in the negative electrode 126 is different for each energy storage cell 12. The timing and degree of the precipitation of the dendrite lithium metal vary depending on the energy storage cell 12, and the timing of the generation of the internal short-circuit caused by the dendrite lithium metal varies depending on the energy storage cell 12. It is difficult to predict the timing at which the internal short-circuit occurs in each energy storage cell 12 and to perform the control based on the prediction.

The energy storage apparatus 1 of the first embodiment continues the operation even when the internal short-circuit occurs in some of the energy storage cells 12, so that the energy storage apparatus 1 can perform the operation regardless of the timing at which the internal short-circuit occurs. The flight vehicle 2 used as the HAPS is required to continuously fly for a long period such as half a year, and the energy storage apparatus 1 provided in the flight vehicle 2 needs to operate for a long period of time without maintenance. The energy storage apparatus 1 continues the operation even when the internal short-circuit occurs in some of the energy storage cells 12, so that the energy storage apparatus 1 can operate for a long period of time without maintenance. Accordingly, the energy storage apparatus 1 of the first embodiment can be used as the energy storage apparatus included in the flight vehicle 2 used as the HAPS. In addition, the energy storage apparatus 1 continues the operation even when the internal short-circuit occurs in some of the energy storage cells 12, so that the energy storage apparatus 1 can operate for a long period of time even when the energy storage cell 12 in which the active material of the negative electrode 126 is the metallic lithium or the alloy containing the lithium is used. The energy storage apparatus 1 using the energy storage cell 12 in which the active material of the negative electrode 126 is the metallic lithium or the alloy containing the lithium has the high discharge capacity, and is useful as the energy storage apparatus provided in the flight vehicle 2 used as the HAPS.

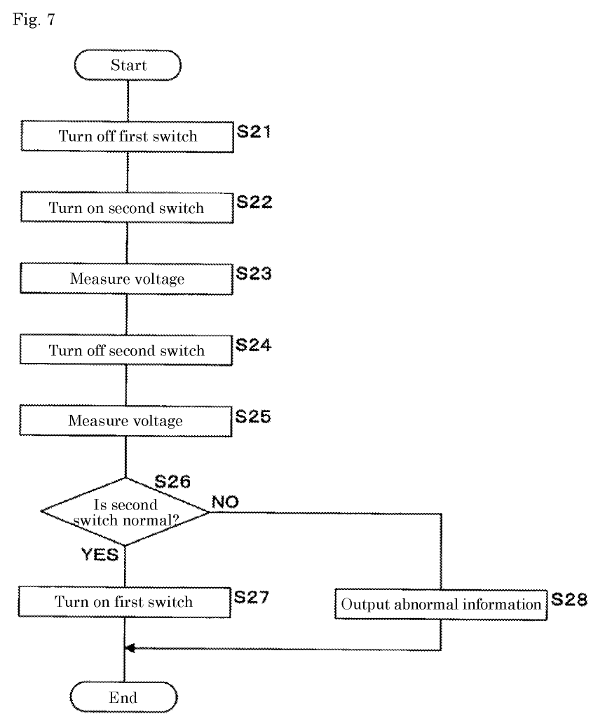

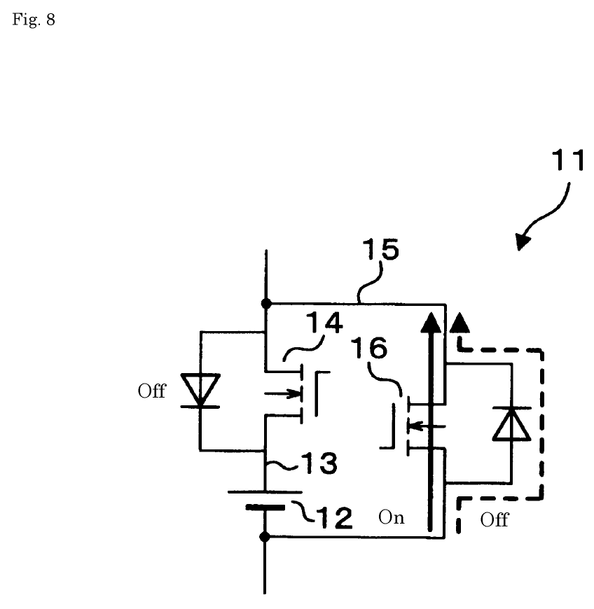

The CMU 3 performs processing for diagnosing whether the first switch 14 and the second switch 16 are in the normal state in which the first electrical path 13 and the second electrical path 15 can be opened and closed. FIG. 7 is a flowchart illustrating a procedure of the processing in which the CMU 3 diagnoses the second switch 16. FIG. 8 is a schematic circuit diagram illustrating the battery circuit 11 when the second switch 16 is diagnosed. The CMU 3 diagnoses the second switch 16 when the energy storage apparatus 1 performs the discharge.

In the initial state, the first switch 14 is turned on, and the second switch 16 is turned off. During the discharge, the arithmetic unit 31 turns off the first switch 14 by the switching unit 36 (S21), and then turns on the second switch 16 in the battery circuit 11 including the first switch 14 that is turned off by the switching unit 36 (S22). In the state where the second switch 16 is turned on, the current flows through the second switch 16 as indicated by a solid arrow in FIG. 8. The voltage measurement unit 34 measures the voltage across the second switch 16 (S23). When the second switch 16 is normal, the measured voltage is approximately 0 V.

Subsequently, the arithmetic unit 31 turns off the second switch 16 by the switching unit 36 (S24). In the state where the second switch 16 is turned off, the current flows through the body diode included in the second switch 16 as indicated by a broken arrow in FIG. 8. The voltage measurement unit 34 measures the voltage across the second switch 16 (S25). When the second switch 16 is normal, the measured voltage is higher than the voltage when the second switch 16 is turned on. For example, the voltage across the second switch 16 is 0.6 V to 1 V.

The arithmetic unit 31 determines whether the second switch 16 is normal based on the voltages measured in S23 and S25 (S26). For example, the arithmetic unit 31 determines that the second switch 16 is normal in the case where the voltage when the second switch 16 is turned on is a low value close to 0 V and in the case where the voltage when the second switch 16 is turned off is included in a higher predetermined range. For example, when a difference between the voltage when the second switch 16 is turned on and the voltage when the second switch is turned off does not exist, the arithmetic unit 31 determines that the second switch 16 is in the abnormal state in which the second electrical path 15 cannot be reliably opened and closed.

When the second switch 16 is normal (YES in S26), the arithmetic unit 31 turns on the first switch 14 (S27), and ends the processing. The time required for the processing of S21 to S27 is a short time of about 1 second to several seconds, and there is no influence on the operation of the energy storage apparatus 1. When the second switch 16 is abnormal (NO in S26), the arithmetic unit 31 causes the output unit 37 to output abnormality information indicating that the second switch 16 is abnormal (S28), and ends the processing. For example, the abnormality information is input to the control device of the flight vehicle 2, and processing such as notification to the outside of the flight vehicle 2 is performed.

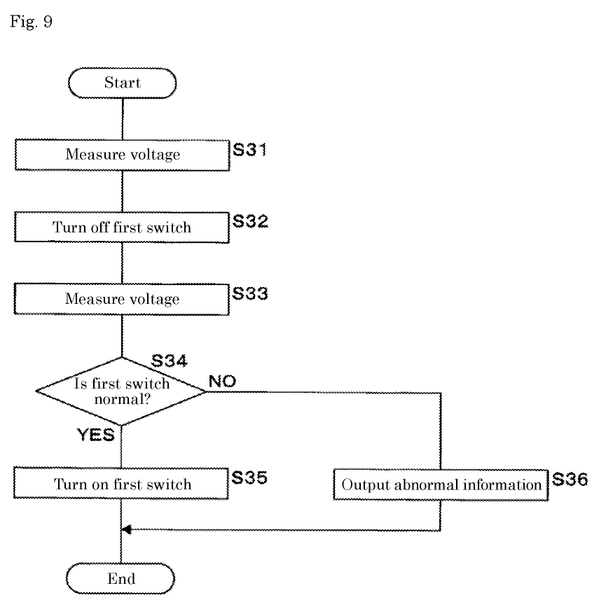

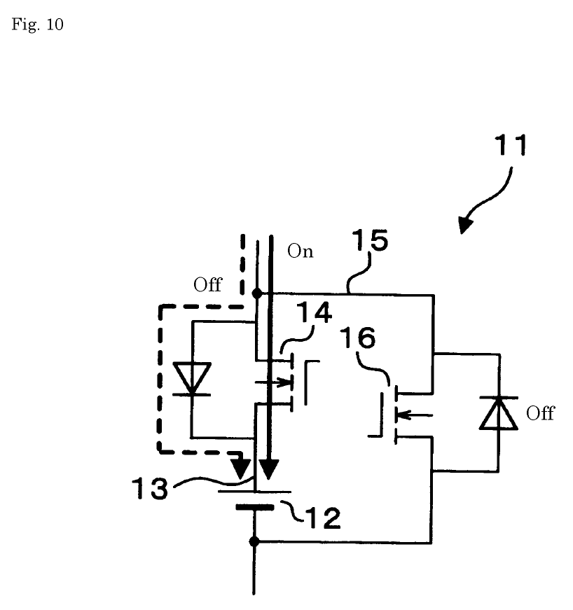

FIG. 9 is a flowchart illustrating a procedure of processing in which the CMU 3 diagnoses the first switch 14. FIG. 10 is a schematic circuit diagram illustrating the battery circuit 11 when the first switch 14 is diagnosed. The CMU 3 diagnoses the first switch 14 when the energy storage apparatus 1 performs the charge. In the initial state, the first switch 14 is turned on, and the second switch 16 is turned off. In the state where the first switch 14 is turned on, the current flows through the first switch 14 as indicated by a solid arrow in FIG. 10. During the charge, the voltage measurement unit 34 measures the voltage across the first switch 14 (S31). When the first switch 14 is normal, the measured voltage is approximately 0 V.

Subsequently, the arithmetic unit 31 turns off the first switch 14 by the switching unit 36 (S32). In the state where the first switch 14 is turned off, the current flows through the body diode included in the first switch 14 as indicated by a broken arrow in FIG. 10. The voltage measurement unit 34 measures the voltage across the first switch 14 (S33). When the first switch 14 is normal, the measured voltage is higher than the voltage when the first switch 14 is turned on. For example, the voltage across the first switch 14 is 0.6 V to 1 V.

The arithmetic unit 31 determines whether the first switch 14 is normal based on the voltages measured in S31 and S33 (S34). For example, the arithmetic unit 31 determines that the first switch 14 is normal in the case where the voltage when the first switch 14 is turned on is a low value close to 0 V and in the case where the voltage when the first switch 14 is turned off is included in a higher predetermined range. For example, when the difference between the voltage when the first switch 14 is turned on and the voltage when the first switch is turned off does not exist, the arithmetic unit 31 determines that the first switch 14 is in the abnormal state in which the first electrical path 13 cannot be reliably opened and closed.

When the first switch 14 is normal (YES in S34), the arithmetic unit 31 turns on the first switch 14 (S35), and ends the processing. The time required for the pieces of processing of S31 to S35 is a short time of about 1 second to several seconds, and there is no influence on the operation of the energy storage apparatus 1. When the first switch 14 is abnormal (NO in S34), the arithmetic unit 31 causes the output unit 37 to output abnormality information indicating that the first switch 14 is abnormal (S36), and ends the processing.

The pieces of processing of S21 to S28 and the pieces of processing of S31 to S36 are sequentially performed for the plurality of battery circuits 11. The energy storage apparatus 1 can check that the first switch 14 and the second switch 16 are normal by diagnosing the first switch 14 and the second switch 16, and can continue the charge and the discharge. When it is determined that the first switch 14 or the second switch 16 is abnormal, processing for stopping the energy storage apparatus 1 such as landing of the flight vehicle 2 can be performed.

Alternatively, the first switch 14 and the second switch 16 may be connected in the battery circuit 11 with a polarity opposite to the polarity in FIGS. 2, 5, 6, 8, 10. In this case, the pieces of processing of S21 to S28 are performed during the charge, and the pieces of processing of S31 to S36 are performed during the discharge.

As described above in detail, in the first embodiment, the first switch 14 that opens and closes the first electrical path 13 in order to connect with another energy storage cell 12, and the second electrical path 15 and the second switch 16 constituting the bypass are attached to each of all the electric storage cells 12. When the energy storage cell 12 is abnormal, the first switch 14 is turned off and the second switch 16 is turned on, and the current bypasses the energy storage cell 12 and flows through the second electrical path 15. The operation of the energy storage apparatus 1 can be continued even when some of the energy storage cells 12 are abnormal. For this reason, the energy storage apparatus 1 can use the energy storage cell 12 in which the internal short-circuit is easily caused. By using the energy storage cell 12 having the high discharge capacity although the internal short-circuit is easily caused, the energy storage apparatus 1 has the high discharge capacity and is useful as the energy storage apparatus provided in the flight vehicle 2 used as the HAPS requiring the high discharge capacity.

### Second Embodiment

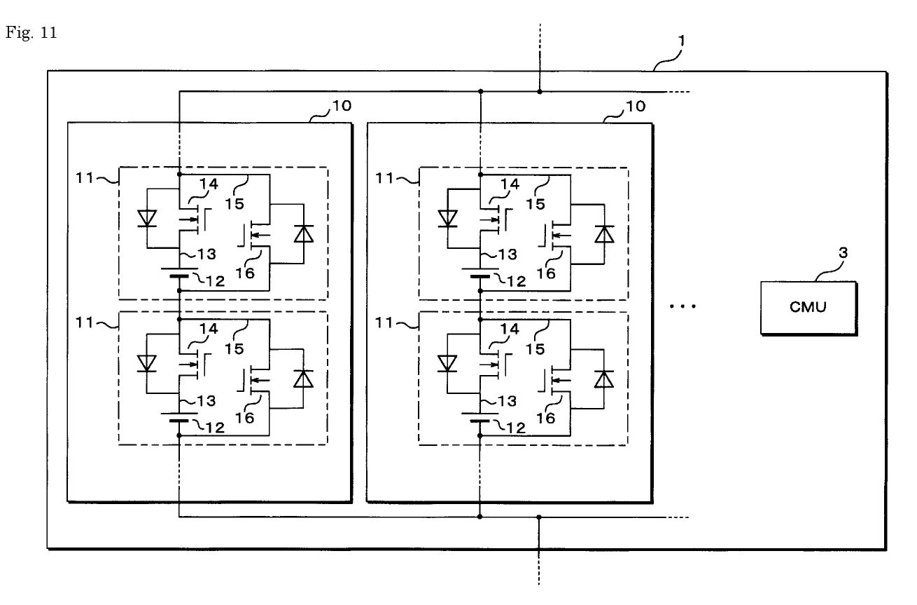

In a second embodiment, the configuration of portions of the flight vehicle 2 other than the energy storage apparatus 1 is the same as that of the first embodiment. FIG. 11 is a block diagram illustrating an example of a functional configuration of an inside of an energy storage apparatus 1 according to a second embodiment. The energy storage apparatus 1 includes a plurality of energy storage modules 10. The plurality of energy storage modules 10 are connected in parallel to each other. The energy storage module 10 includes a plurality of battery circuits 11 connected in series to each other. The configuration of the battery circuit 11 is similar to that of the first embodiment. The energy storage apparatus 1 includes a CMU 3. A functional configuration of an inside of the CMU 3 is similar to that of the first embodiment. The plurality of energy storage modules 10 are connected to a load 21 and a solar cell 22 outside the energy storage apparatus 1. When the energy storage apparatus 1 performs the charge and the discharge, the current flows through the plurality of energy storage modules 10, and each energy storage cell 12 performs the charge and the discharge.

The CMU 3 executes processing similar to that of the first embodiment on each of the energy storage modules 10. Also, in the second embodiment, when the energy storage cell 12 is abnormal, the current bypasses the energy storage cell 12 and flows through the second electrical path 15. The operation of the energy storage apparatus 1 can be continued even when some of the energy storage cells 12 are abnormal. The energy storage apparatus 1 can use the energy storage cell 12 having the high discharge capacity although the internal short-circuit is easily caused, and is useful as the energy storage apparatus provided in the flight vehicle 2 requiring the high discharge capacity.

In the second embodiment, even when the current is turned off in performing the diagnosis processing of the first switch 14 or the second switch 16 in one energy storage module 10, the current flows to another energy storage module 10, and the energy storage apparatus 1 can continue the operation. The CMU 3 may perform processing for bringing each energy storage module 10 into the non-connection state with another energy storage module 10. For example, when detecting the abnormality of the first switch 14 or the second switch 16, the CMU 3 may perform the processing for bringing the energy storage module 10 including the abnormal first switch 14 or second switch 16 into the disconnected state to continue the operation of the energy storage apparatus 1.

In the first and second embodiments, the FETs are used as the first switch 14 and the second switch 16. Alternatively, the first switch 14 and the second switch 16 may be configured using an element other than the FET. The energy storage cell 12 may be a battery other than the lithium ion battery. The flight vehicle 2 may include a plurality of energy storage apparatuses 1.

In the first and second embodiments, the first switch 14 is provided in the first electrical path 13 such that the forward direction of the diode is the charge direction of the energy storage apparatus 1, and the second switch 16 is provided in the second electrical path 15 such that the forward direction of the diode is the discharge direction of the energy storage apparatus 1. With this configuration, during the discharge of the energy storage apparatus 1, processing for flowing the current while bypassing the predetermined energy storage cell 12 can be quickly performed. Alternatively, the diode of the first switch 14 and the diode of the second switch 16 may be in opposite directions. In other words, one of the diode included in the first switch 14 and the diode included in the second switch 16 may be disposed such that the charge direction of the energy storage apparatus 1 is the forward direction, and the other may be disposed such that the discharge direction of the energy storage apparatus 1 is the forward direction.

In the first and second embodiments, the CMU 3 performs the function of the controller. Alternatively, an upper-level management apparatus capable of communicating with the CMU 3 or a remotely disposed management apparatus capable of communicating with the energy storage apparatus 1 may function as the controller. In other words, the circuit board including the first switch 14 and the second switch 16 and the circuit board including the controller may be physically separated from each other. The energy storage apparatus 1 may be mounted on a mobile body other than the flight vehicle 2.

The present invention is not limited to the contents of the above embodiments, but various modifications can be made within the scope of the claims. That is, an embodiment obtained by combining technical means appropriately changed within the scope of the claims is also included in the technical scope of the present invention.

1. An energy storage apparatus used in a flight vehicle, the energy storage apparatus comprising:
a plurality of battery circuits connected in series, through which current flows during charge and discharge of the energy storage apparatus,
wherein each of the battery circuits includes:
a first electrical path;
an energy storage cell connected to an adjacent battery circuit through the first electrical path;
a first switch that includes a diode and is provided in the first electrical path such that a forward direction of the diode is a charge direction of the energy storage apparatus;
a second electrical path connected to the adjacent battery circuit in parallel with the energy storage cell and the first switch; and
a second switch that includes a diode and is provided in the second electrical path such that a forward direction of the diode is a discharge direction of the energy storage apparatus, and is turned on when the first switch is turned off.

2. The energy storage apparatus according to claim 1, further comprising
a controller that controls switching between turn-on and turn-off of the first switch and the second switch such that a positive electrode terminal and a negative electrode terminal of the energy storage cell are not short-circuited outside the energy storage cell, in each battery circuit.

3. The energy storage apparatus according to claim 2, wherein
the controller determines that the energy storage cell is normal or abnormal, and turns off the first switch in the battery circuit that includes the energy storage cell determined to be abnormal, and
then, turns on the second switch.

4. The energy storage apparatus according to claim 3, wherein
the controller determines that the energy storage cell is normal or abnormal based on voltage of the energy storage cell.

5. The energy storage apparatus according to claim 3, wherein
the controller determines that the energy storage cell is normal or abnormal based on voltage of the energy storage cell at a time of charging the energy storage cell.

6. The energy storage apparatus according to claim 2 wherein
the first switch and the second switch are configured using an FET, and
the controller diagnoses that one of the first switch and the second switch is normal or abnormal while being charged, and diagnoses that the other of the first switch and the second switch is normal or abnormal while being discharged.

7. An energy storage apparatus comprising:
a plurality of battery circuits connected in series, through which current flows during charge and discharge of the energy storage apparatus, wherein
each of the battery circuits includes:
a first electrical path;
an energy storage cell connected to an adjacent battery circuit through the first electrical path;
a first switch provided in the first electrical path;
a second electrical path connected to the adjacent battery circuit in parallel with the energy storage cell and the first switch; and
a second switch that is provided in the second electrical path and is turned on when the first switch is turned off, and
one of a diode included in the first switch and a diode included in the second switch is disposed such that a charge direction of the energy storage apparatus is a forward direction, and the other of the diodes is disposed such that a discharge direction of the energy storage apparatus is the forward direction.

8. The energy storage apparatus according to claim 1 wherein
an active material of a negative electrode of the energy storage cell is metallic lithium or an alloy containing lithium.
